(19) United States
(12) Patent Application Publication
(10) Pub. No.: US 2009/0087363 A1
(43) Pub. Date: Apr. 2, 2009

(54) ENCAPSULATION OF METAL CATALYSTS IN INERT POROUS MATRICES FOR REMOVAL OF CARBON DIOXIDE FROM AEROSOL COMPONENTS

(75) Inventors: Arvind Vyas Harinath, Greensboro, NC (US); Ramya Vedaiyan, Greensboro, NC (US); Jagannathan Sankar, Greensboro, NC (US)

Correspondence Address: MYERS BIGEL SIBLEY & SAJOVEC, PO BOX 37428, RALEIGH, NC, 27627, US

(73) Assignee: North Carolina Agricultural and Technical State University

(21) Appl. No.: 12/240,389

(22) Filed: Sep. 29, 2008

Related U.S. Application Data
(60) Provisional application No. 60/976,093, filed on Sep. 28, 2007.

(51) Int. Cl. B01D 53/94; B01J 23/52; B01J 23/10; B01J 21/18; B01J 21/04; B01J 29/04; B01D 53/62

(52) U.S. Cl. 423/213.2; 502/344; 502/304; 502/180; 502/355; 502/60; 423/247

(57) ABSTRACT

The present invention provides an encapsulation technology and methods of using the encapsulation technology in processes involving the conversion of carbon monoxide to carbon dioxide.

### RELATED APPLICATION DATA

This application claims priority to and the benefit of U.S. Patent Application Ser. No. 60/976,093, filed Sep. 28, 2007, the disclosure of which is incorporated by reference herein in its entirety.

### FIELD OF THE INVENTION

The present invention generally concerns methods of encapsulating metal catalysts in porous matrices for removal of carbon dioxide from an environment and encapsulated metal catalysts provided by the encapsulation technology described herein.

### BACKGROUND OF THE INVENTION

It is widely known that carbon monoxide is a poisonous gas. Carbon monoxide is present in the exhaust gas from automobiles as well as in cigarette smoke. Both the cigarette and automobile industries have tremendous interest in developing means to eliminate or to reduce its concentration. Catalysts that may be effective in these applications are metal-metal oxide catalysts. We have demonstrated in our laboratory that nanoparticles of gold, supported on aluminum oxide, can oxidize carbon monoxide to carbon dioxide at room temperature. Use of such catalysts in cigarette and automobiles can reduce the amount of carbon monoxide in smoke or exhaust gas. The catalysts, however, are deactivated by certain components of cigarette smoke or exhaust gas.

Processes disclosed herein, as they relate to the present invention, describe an encapsulation technology that can reduce the exposure of the catalysts to particular aerosol components that deactivate the catalysts.

### BRIEF DESCRIPTION OF THE DRAWINGS

FIG. 1. FIG. 1 presents a schematic showing the conversion of carbon monoxide to carbon dioxide using the encapsulation technology described herein.

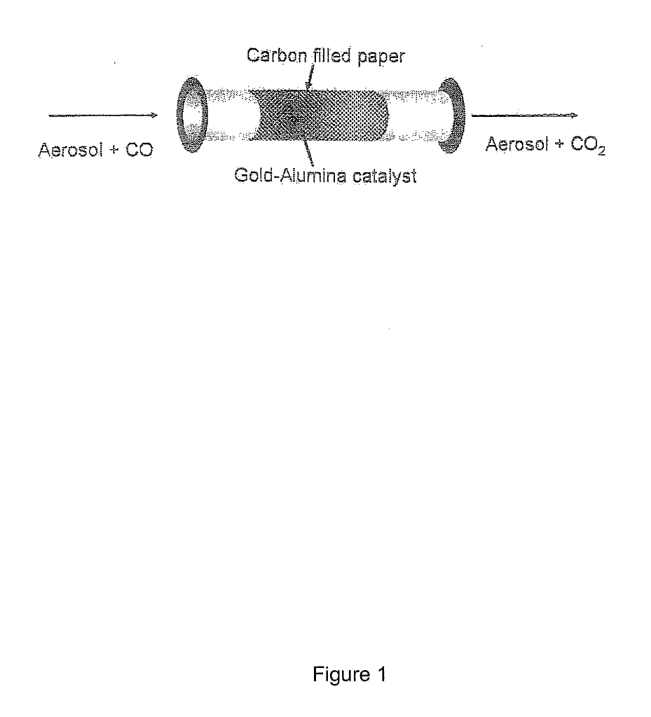

### SUMMARY OF THE INVENTION

The present invention provides an encapsulation technology that provides encapsulated metal catalysts that can be used to prevent catalyst deactivation by high molecular weight organics absorbed on the catalyst surface blocking active sites for carbon monoxide oxidation; provide an efficient method for dispersing active catalysts in the matrices; maintain catalyst activity after encapsulation; and/or facilitate-improved handling of the catalyst.

Accordingly, aspects of the present invention relate to methods of controlling or reducing the exposure of a catalyst to components in an environment that deactivate the catalyst.

Further aspects of the present invention include processes for the oxidation of carbon monoxide in a carbon monoxide-containing environment including introducing an encapsulated catalyst to the environment, wherein the encapsulated catalyst includes a catalyst encapsulated by a matrix including an adsorbent that deactivates the catalyst.

Aspects of the present invention further relate to methods of encapsulating a catalyst including forming an encapsular enclosure around the catalyst, wherein the enclosure includes a matrix and an adsorbent that deactivates the catalyst.

Additional aspects of the present invention provide encapsulated catalysts formed by the methods described herein.

### DETAILED DESCRIPTION

The foregoing and other aspects of the present invention will now be described in more detail with respect to other embodiments described herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a,” “an” and “the” are intended to include the plural forms as well, unless the context clearly indicates otherwise. As used herein, the term “and/or” includes any and all combinations of one or more of the associated listed items.

Unless otherwise defined, all technical and scientific terms used herein have the same meaning as commonly understood by one of ordinary skill in the art to which this invention belongs.

It will be understood that steps comprising the methods provided herein can be performed independently or at least two steps can be combined when the desired outcome can be obtained.

Embodiments of the present invention provide methods of controlling or reducing the exposure of a catalyst to components in an environment that deactivate the catalyst. In particular embodiments, the method comprises encapsulating a catalyst in an encapsulating material comprising a matrix and further comprising an adsorbent that inhibits the activity of the component that deactivates the catalyst. The adsorbent can be selected or designed by one skilled in the art. More specifically, the adsorbent can be selected or designed based upon its characteristics to inhibit the effect of the deactivating agent on the catalyst. For example, the adsorbent may be a compound known to bind to the deactivating agent resulting in the disruption of the inhibitory effect of the deactivating agent on the catalyst, and thus, allowing the catalyst to remain active. As used herein, “inhibit” refers to a reduction in activity. The reduction may be complete or partial reduction of activity.

Embodiments of the present invention further provide methods to prevent catalyst deactivation by high molecular weight organics that absorb on the catalyst surface blocking the active sites for carbon monoxide oxidation. Such organics include pyrazine and nicotine.

Embodiments of the present invention further provide methods of encapsulating a catalyst including encapsulating a catalyst, wherein the encapsulating material includes a matrix further including an adsorbent that deactivates the catalyst. Methods of encapsulating a catalyst according to embodiments of the present invention further include forming an encapsular enclosure around the catalyst, wherein the enclosure includes a matrix and an adsorbent that deactivates the catalyst. As used herein, “enclosure” refers to a material surrounding the catalyst. The enclosure is structured such that a gaseous, such as a vapor or aerosol, environment can enter and/or exit the encapsular enclosure.

In some embodiments, the catalyst is a metal catalyst. In other embodiments, the catalyst includes more than one metal and/or includes an oxide. In further embodiments, the catalyst is a gold catalyst, a gold-aluminum oxide catalyst or a gold-cerium oxide catalyst.

In some embodiments, the matrix is a material that provides support for an adsorbent and allows gases, vapors and/or aerosols, and thus, air, smoke, exhaust fumes, etc. to pass through the structure formed by the matrix. In some embodiments, the matrix is an inert material. In some embodiments, the matrix is a polymeric structure. In further embodiments, the matrix is a cellulosic or porous polymeric structure. In some embodiments, the cellulosic structure is paper or cloth.

In some embodiments of the present invention, the adsorbent is activated carbon, activated aluminum oxide, zeolites or molecular sieves.

Embodiments of the present invention further provide processes for the oxidation of carbon monoxide in a carbon monoxide-containing environment including introducing an encapsulated catalyst to the environment, wherein the encapsulated catalyst includes a catalyst encapsulated by a matrix in the presence of an adsorbent that deactivates the catalyst.

In some embodiments, the matrix includes the adsorbent in the material or structure of the matrix. In some embodiments, the matrix is a separate material from the adsorbent material.

In particular embodiments, the carbon monoxide-containing environment is produced by an aerosol source. In other embodiments, the carbon monoxide-containing environment is smoke produced by recreational smoking products such as tobacco smoke, e.g., cigarette, cigar and pipe smoke, or automobile exhaust.

Embodiments of the present invention also provide encapsulated catalysts formed by the methods described herein.

Embodiments of the present invention provide an efficient method for dispersing active catalysts in a matrix.

Embodiments of the present invention also allow selective oxidation of carbon monoxide.

Embodiments of the present invention further allow maintenance of catalytic activity after encapsulation.

Embodiments of the present invention will be further explained with reference to the following example, which is included herein for illustration purposes only, and which is not intended to be limiting of the invention.

### EXAMPLE

### Encapsulation of a Gold-Aluminum Oxide Catalyst

A gold-aluminum oxide catalyst was encapsulated in a paper filled with activated carbon. The activity of the encapsulated catalyst was compared with the catalyst without encapsulation. The result is presented in the following table.

TABLE 1
Catalyst-Mediated Carbon Monoxide Conversion

| Gold-Aluminum Catalyst | % Conversion |
|---|---|
| Without Encapsulation | 50 |
| With Encapsulation | 50 |

The foregoing is illustrative of the present invention, and is not to be construed as limiting thereof. The invention is defined by the following claims, with equivalents of the claims to be included therein.

That which is claimed is:

1. A method of reducing the exposure of a catalyst to components in an environment that deactivate the catalyst, the method comprising encapsulating a catalyst in an encapsulating material comprising a matrix and an adsorbent that inhibits the activity of the component that deactivates the catalyst.

2. The method of claim 1, wherein the catalyst is a metal catalyst.

3. The method of claim 1, wherein the catalyst is a gold catalyst.

4. The method of claim 1, wherein the catalyst is a metal oxide catalyst.

5. The method of claim 2, wherein the catalyst comprises more than one metal.

6. The method of claim 5, wherein the catalyst comprises an oxide.

7. The method of claim 6, wherein the catalyst is a gold-aluminum oxide catalyst.

8. The method of claim 6, wherein the catalyst is a gold-cerium oxide catalyst.

9. The method of claim 1, wherein the matrix is a cellulosic or porous polymeric structure.

10. The method of claim 9, wherein the cellulosic structure is paper or cloth.

11. The method of claim 1, wherein the adsorbent is activated carbon, activated aluminum oxide, zeolites or molecular sieves.

12. The method of claim 1, wherein the matrix further comprises an adsorbent.

13. A process for the oxidation of carbon monoxide in a carbon monoxide-containing environment comprising introducing an encapsulated catalyst to said environment, wherein the encapsulated catalyst comprises a catalyst encapsulated by a matrix and an adsorbent that inhibits the activity of a compound that deactivates the catalyst.

14. The process of claim 13, wherein the catalyst is a metal catalyst.

15. The process of claim 13, wherein the catalyst is a gold catalyst.

16. The process of claim 13, wherein the catalyst is a metal oxide catalyst.

17. The process of claim 14, wherein the catalyst comprises more than one metal.

18. The process of claim 17, wherein the catalyst comprises an oxide.

19. The process of claim 18, wherein the catalyst is a gold-aluminum oxide catalyst.

20. The process of claim 18, wherein the catalyst is a gold-cerium oxide catalyst.

21. The process of claim 13, wherein the matrix is a cellulosic or porous polymeric structure.

22. The process of claim 21, wherein the cellulosic structure is paper or cloth.

23. The process of claim 13, wherein the adsorbent is activated carbon, activated aluminum oxide, zeolites or molecular sieves.

24. The process of claim 13, wherein the carbon monoxide-containing environment is produced by an aerosol source.

25. The process of claim 13, wherein the carbon monoxide-containing environment is cigarette smoke or automobile exhaust.

26. A method of encapsulating a catalyst comprising encapsulating a catalyst, wherein the encapsulating material comprises a matrix and an adsorbent that inhibits the activity of a component of an environment that deactivates the catalyst.

27. An encapsulated metal catalyst comprising a metal catalyst encapsulated in a matrix, said matrix having an adsorbent that inhibits the activity of a component of an environment that deactivates the catalyst.
